(19) United States
(12) Patent Application Publication
(10) Pub. No.: US 2017/0027162 A1
(43) Pub. Date: Feb. 2, 2017

(54) SUSPENSION CONCENTRATE

(71) Applicants: Robert L. HODGE, Sumter, SC (US); Keith BRANLY, Brandon, FL (US)

(72) Inventors: Robert L. HODGE, Sumter, SC (US); Keith BRANLY, Brandon, FL (US)

(21) Appl. No.: 14/815,877

(22) Filed: Jul. 31, 2015

(51) Int. Cl. A01N 25/04; A01N 39/04; A01N 37/40; A01N 43/90; A01N 43/653

(52) U.S. Cl. CPC A01N 25/04; A01N 43/90; A01N 43/653; A01N 37/40; A01N 39/04

(57) ABSTRACT

An aqueous suspension concentrate containing: (a) a first active ingredient comprising one or more triazolopyrimidine, triazolone, pyrazole or oxazole herbicides; (b) optionally, a second active ingredient, (c) a dispersant comprising a comb polymer; (d) a nonionic, alkoxylated surfactant or a block copolymer surfactant, and (e) optionally, a re-dispersing agent, wherein said aqueous suspension concentrate exhibits an acidic pH within the range from about greater than about 2 to about 4.

### FIELD OF THE INVENTION

The invention relates to aqueous suspension concentrates exhibiting low pH, high stability, and a redispersion agent to avoid the formation of hard sediment and facilitate re-suspension of any settled particulates.

### BACKGROUND OF THE INVENTION

Agrochemicals are typically available in a number of different physical forms and formulations. Some of these forms are intended to address the varying strengths and weaknesses of the active ingredient as well as the applicable regulations associated with that ingredient. Other forms address the area where the product is most likely to be used and the types of application equipment that tend to prevail in that region. High concentration formulations of single or multiple active ingredients are desirable for a variety of economic and environmental reasons, including the reduction of shipping and handling costs. Liquid pre-mix concentrates containing two or more active ingredients are useful in a wide variety of agricultural applications. For example, two or more pesticidal active ingredients may be combined in order to control a wider spectrum of pests, or to utilize multiple modes of action, compared to the individual active ingredients alone.

The term “aqueous suspension concentrates” refers to suspension concentrates based on water. The water component of the suspension concentrates of the invention can be in an amount of about 25-98% by weight in general. The unit “% by weight” (percent by weight) generally refers to the relative weight of the respective component based on the total weight of the formulation.

Active ingredients in a suspension concentrate can be soluble or insoluble in aqueous solutions. Both present their own problems in formulating a suspension concentrate. For example, the production of a stable, water-based suspension concentrate formulation of a water-soluble pesticide is difficult due to the formation of clogging crystals in the process known as Ostwald ripening. Finely divided solids suitable for suspension can also agglomerate during storage and form aggregates that are sufficiently large to clog spray nozzles or form sediment in the container or spray tank. Maintaining a stable suspension concentrate with a uniform particle size distribution (i.e., no large crystals) is most important for this type of formulation in order to prevent settling of particles during storage.

The preparation of liquid single active concentrates and pre-mix concentrates that are physically stable remain a challenge as temperature fluctuations can materially affect the solubility characteristics of relatively insoluble active ingredients that have been formulated into a suspension. Symptoms of physical instability include phase separation, crystallization, settling, sedimentation, gelling, and agglomeration. Formulations that also combine a water-soluble ingredient (even in the ppm range) with a water-insoluble ingredient, e.g., solids present additional challenges.

In general, “water insoluble” refers to pesticides having sparing solubility in deionized water at 20° C., e.g., of not greater than about 100 milligrams per liter (mg/L). In some embodiments the pesticides have solubility in deionized water at 20° C. of not greater than about 75 mg/L. In some embodiments the pesticides have solubility in deionized water at 20° C. of not greater than about 50 mg/L. In some embodiments the pesticides have solubility in deionized water at 20° C. of not greater than about 25 mg/L. In certain embodiments, “solid” refers to pesticides having a melting point not less than about 75° C. In some embodiments, the water insoluble pesticide has a melting point not less than about 100° C., and in other embodiments, not less than about 150° C.

Published U.S. Patent Application No. 2013/0331267 describes suspension premix concentrates that contain a dispersed phase containing a water insoluble pesticide, a continuous phase containing a water soluble salt of a pesticide, a rheology agent, and a wetting-dispersing agent.

U.S. Pat. No. 6,569,809 teaches a pre-mix concentrate made with a water soluble agent dissolved in the aqueous phase and a water insoluble agent that is surrounded by a barrier layer made with an organic solvent or emulsifying agent with an HLB of at least 15. A suitable viscosity modifying agent is colloidal hydrophilic silica that is dispersed in the aqueous phase.

WO 2002/036595 teaches a sulfonamide in an aqueous suspension concentrate containing deionized water, xanthan gum, carboxylmethyl cellulose; 1, 2-benzisothiazolin-3-one; naphthalene sulfonate; silicone fluid; ethylene oxide/propylene oxide block copolymer; phosphoric acid; and propylene glycol.

U.S. Pat. No. 8,653,002 relates to an aqueous suspension concentrate having a pH within the range of 2-7 and containing 2-chloro-5-[3,6-dihydro-3-methyl-2,6-dioxo-4-(trifluoromethyl)-1-(2H)pyrimidinyl]-4-fluoro-N-[[methyl(1-methylethyl)amino]sulfonyl] benzamide (saflufenacil) in the form of its crystalline anhydrate; at least one non-ionic surfactant selected from polyoxyethylene-polyoxy-C3-C4-alkylene block copolymers; and at least one anionic surfactant comprising at least one arylsulfonate group.

Triazolopyrimidine, triazolone, pyrazole and oxazole herbicides have posed unique challenges for a suspension concentrate. These active ingredients exhibit increased water solubility as the pH and/or water hardness of the water system is increased. This solubility has generated agglomerates during storage and upon dilution with water sources of varying chemical properties, such as especially hard water or high pH, to the end use product. These agglomerates can cause substantial clogging problems with spray equipment. These active ingredients can also form a hard sediment that does not readily redisperse when trying to make the end use product.

Rheology modifying additives can be used to thicken aqueous suspension concentrates. If, however, the aqueous phase has a high content of water soluble salt of a herbicidal active ingredient, the thickeners may be incompatible with the high ionic strength of the aqueous phase. This incompatibility can develop phase separation as well as precipitation of solids upon storage and/or shipping under the effects of changing temperature and quiescent storage time. Unless the precipitates can be readily redispersed, the product cannot be used or sold.

### SUMMARY OF THE INVENTION

In accordance with the present invention, aqueous suspension concentrates according to the invention comprise: (a) an active ingredient whose water solubility increases as the pH increases towards neutral, such as a triazolopyrimidine, triazolone, pyrazole or oxazole; (b) a dispersant comprising a comb polymer; (c) an acid stable, anionic surfactant; and (d) optionally, a redispersion agent, wherein the suspension concentrate exhibits an acidic pH within the range from about 2.5 to about 3.5.

The present formulation provides a stable, high concentration suspension of triazolopyrimidine, triazolone, pyrazole, and oxazole herbicides as well as mixtures thereof and mixtures with one or more active ingredients of a different type that exhibit good redispersability and convenient use. The comb polymer and polyarylphenol phosphate provide a stable dispersion system, and the optional redispersion agent provides a soft lattice of suspending nucleating agents that avoid the formation of hard sediment of any precipitated active agent, even when hard water and/or high pH water are used for dilution to the end use product. Moderate agitation or shaking of the container will redisperse any such sediment so that the end use product can be made without nozzle clogging agglomerates.

### DETAILED DESCRIPTION OF THE INVENTION

A stable aqueous suspension concentrate according to the invention comprises: (a) a first active ingredient comprising one or more triazolopyrimidine, triazolone, pyrazole or oxazole herbicides; (b) an optional second active ingredient; (c) a dispersant comprising a comb polymer; (d) an acid stable, nonionic surfactant; and, (e) optionally, a redispersion agent, wherein said suspension concentrate exhibits an acidic pH within the range from greater than about 2 to about 4, preferably about 2.5 to about 3.5.

Compositions according to the invention comprise concentrations according to the table 1:

TABLE 1

| | Suitable Range | Preferred Range |
|---|---|---|
| Ingredient | (total wt %) | (total wt %) |
| Active ingredient | 5-85 | 5-65 |
| Comb polymer dispersant | 0.01-15 | 0.1-7.5 |
| Nonionic surfactant | 0.25-10% of each | 0.5-5% of each |
| Redispersion agent | 0.1-10 | 0.3-5 |

The suspension concentrate of the present invention provides an aqueous suspension that contains an amount of the active ingredient that is within the range from about 1 g/l to about 800 g/l, preferably within the range from about 240 to about 480 g/l.

As used herein, the term “stable composition” refers to compositions that are stable physically and/or chemically for defined periods of time to the environments in which they are produced, transported and/or stored. Aspects of “stable compositions” include, but are not limited to: physical stability at temperatures that range from about 0° C. to about 60° C., homogeneity, pourability, liquids that do not exhibit appreciable sedimentation or Ostwald ripening of the dispersed particles, compositions that form little or no precipitated solids or exhibit phase separation, compositions that readily disperse when poured into a spray tank of water and retain their biological efficacy when applied, for example, by spray application to target pests. In some embodiments, the compositions form stable, homogeneous suspension concentrates that do not exhibit syneresis and/or exhibit very little change in viscosity under the storage conditions.

In some embodiments, the described compositions are stable at temperatures of greater than or equal to about 40° C. for a period of at least 4 weeks, preferably about 3-4 months. In some embodiments, the described compositions are stable at temperatures greater than or equal to about 54° C. for a period of at least about 3-4 months. In some embodiments, the compositions do not exhibit or do not significantly exhibit separation or precipitation (or crystallization) of any of the components at low temperatures.

In some embodiments, the compositions remain as homogeneous suspension concentrates at temperatures in typical chemical storage conditions for 1-2 seasons. At lower temperatures, the present invention does not freeze or generally separate so as to precipitate sediment. If any such sediment does form, the sediment is a soft lattice that is readily redispersed by gentle mixing.

In some embodiments, the compositions remain as homogeneous suspension concentrates after subjecting them to freeze/thaw (F/T) conditions where the temperature is cycled from about −15° C. for 24 hours to about 54° C. for another 24 hours as one cycle. Typical testing is performed for 5-10 cycles or more. This testing is intended to represent conditions that are typically much harsher than most products would experience under natural weather conditions.

First Active Ingredients

Suspended or dispersed in the aqueous phase of the compositions described herein are one or more water-insoluble solid pesticides of the triazolopyrimidines, triazolones, pyrazoles or oxazoles.

Examples of suitable triazolopyrimidine herbicides include cloransulam, diclosulam, florasulam, flumetsulam, metosulam, penoxsulam and pyroxsulam. Preferred triazolopyrimidine herbicides include cloransulam, florasulam, flumetsulam and penoxsulam.

Examples of suitable aryl triazolones include amicarbazone, bencarbazone, carfentrazone, carfentrazone-ethyl, flucarbazone, ipfencarbazone, propoxycarbazone, sulfentrazone, and thiencarbazone, or an agriculturally acceptable salt, carboxylic acid, carboxylate salt, or ester thereof. Preferred aryl triazolones include amicarbazone, carfentrazone, carfentrazone-ethyl, flucarbazone, propoxycarbazone, sulfentrazone, and thiencarbazone.

Examples of suitable pyrazole herbicides include azimsulfuron, difenzoquat, halosulfuron, metazachlor, metazosulfuron, pyrazosulfuron, pyroxasulfone. Preferred pyrazole herbicides include halosulfuron, metazachlor, and pyroxasulfone. Examples of suitable oxazole herbicides include carboxazole, fenoxasulfone, isouron, isoxaben, isoxachlortole, isoxaflutole, methiozolin, monisouron, pyroxasulfone, and topramezone. Preferred oxazole herbicides include isoxaben, isoxaflutole, pyroxasulfone, and topramezone.

The present invention is particularly well suited for making a suspension concentrate containing cloransulam-methyl. Cloransulam-methyl is an off-white powder that is typically formulated as water-dispersible granules in premeasured water-soluble packets. Suspension concentrates have traditionally been difficult to formulate for cloransulam-methyl due to its tendency to precipitate when mixed in water and form hard, crystalline sediment that is difficult to re-disperse.

Optional 2^{nd} Active

If desired, the present formulation can contain a second type of active ingredient in acid, encapsulated, or protected form that is not a triazolopyrimidine, triazolone, pyrazole or oxazole but which is stable in a low pH system. Such suitable second active ingredients generally include acid forms of: 4-CPA; 4-CPB; 4-CPP; 2,4-D; 2,4-D choline salt, 2,4-D esters and amines, 2,4-DB; 3,4-DA; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bialaphos, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop-propargyl, clofop, clomazone, clomeprop, cloprop, cloproxydim, clopyralid, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenteracol, fenthiaprop, fentrazamide, fenuron, ferrous sulfate, flamprop, flamprop-M, flazasulfuron, fluazifop, fluazifop-P-butyl, fluazolate, flucarbazone, flucetosulfuron, fluchloralin, flufenacet, flufenican, flufenpyr-ethyl, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, fluoroxypyr-meptyl, flurtamone, fluthiacet, fomesafen, foramsulfuron, fosamine, fumiclorac, furyloxyfen, glufosinate, glufosinate-ammonium, glufosinate-P-ammonium, glyphosate salts and esters, halauxifen, halauxifen-methyl, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazosulfuron, cloransulam-methyl, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metoxuron, metribuzin, metsulfuron, metsulfuron-methyl, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen-ethyl, parafluoron, paraquat, pebulate, pelargonic acid, pendimethalin, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfometuron, sulfosate, sulfosulfuron, sulfuric acid, sulglycapin, swep, SYN-523, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thifensulfurn-methyl, thiobencarb, tiocarbazil, tioclorim, topramezone, tralkoxydim, triafamone, tri-allate, triasulfuron, triaziflam, tribenuron, tribenuron-methyl, tricamba, triclopyr choline salt, triclopyr esters and salts, tridiphane, trietazine, trifloxysulfuron, trifluralin, triflusulfuron, trifop, trifopsime, trihydroxytriazine, trimeturon, tripropindan, tritac tritosulfuron, vernolate, xylachlor and salts, esters, optically active isomers and mixtures thereof.

Particularly suitable suspension concentrates according to the invention are mixtures of one or more triazolopyrimidines, triazolones, pyrazoles or oxazoles with one or more second active ingredients that include the amide herbicides, the aromatic acid herbicides, the diphenyl ether herbicides, and the organophosphorous herbicides. These actives amenable to the present invention due to their high water solubility at neutral pH and difficulty in water-based, suspension-concentrates.

Amide herbicides useful in the invention include the sub-groups of anilide herbicides, arylalanine herbicides, chloracetanilide herbicides, sulfonanilide herbicides, sulfonamide herbicides and thioamide herbicides. Suitable amide herbicides include allidochlor, amicarbazone, beflubutamid, benzadox, benzipram, bromobutide, cafenstrole, CDEA, cyprazole, dimethenamid, dimethenamid-P, diphenamid, epronaz, etnipromid, fentrazamide, flucarbazone, flupoxam, fomesafen, halosafen, huangcaoling, isocarbamid, isoxaben, napropamide, napropamide-M, naptalam, pethoxamid, propyzamide, quinonamid, saflufenacil, tebutam, and tiafenacil.

Suitable anilide herbicides include chloranocryl, cisanilide, clomeprop, cypromid, diflufenican, erlujixiancaoan, etobenzanid, fenasulam, flufenacet, flufenican, ipfencarbazone, mefenacet, mefluidide, metamifop, monalide, naproanilide, pentanochlor, picolinafen, propanil, sulfentrazone, and triafamone.

Suitable arylalanine herbicides include benzoylprop, and flamprop especially flamprop-M.

Suitable chloroacetanilide herbicides include acetochlor, alachlor, butachlor, butenachlor, delachlor, diethatyl, dimethachlor, ethachlor, ethaprochlor, metazachlor, metolachlor especially S,-metolachlor, pretilachlor, propachlor, propisochlor, prynachlor, terbuchlor, thenylchlor, and xylachlor.

Suitable sulfonanilide herbicides include benzofluor, cloransulam, diclosulam, florasulam, flumetsulam, metosulam, perfluidone, profluazol, and pyrimisulfan.

Suitable sulfonamide herbicides include asulam, carbasulam, fenasulam, oryzalin, penoxsulam, and pyroxsulam.

Suitable thioamide herbicides include bencarbazone and chlorthiamid.

Suitable aromatic acid herbicides include benzoic acid herbicides (such as cambendichlor, chloramben, dicamba, 2,3,6-TBA, and tricamba); pyrimidinyloxybenzoic acid herbicides (such as bispyribac and pyriminobac); pyrimidinylthiobenzoic acid herbicides (such as pyrithiobac); phthalic acid herbicides (such as chlorthal); picolinic acid herbicides (such as aminopyralid, clopyralid, halauxifen, and picloram); and quinolinecarboxylic acid herbicides (such as quinclorac and quinmerac).

Suitable diphenyl ether herbicides include ethoxyfen and nitrophenyl ether herbicides (such as acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, and oxyfluorfen).

Suitable organophosphorus herbicides include amiprofos-methyl, amiprophos, anilofos, bensulide, bilanafos, butamifos, clacyfos, 2,4-DEP, DMPA, EBEP, fosamine, glufosinate especially glufosinate-P, glyphosate, huangcaoling, piperophos, and shuangjiaancaolin.

Particularly preferred combinations and mixtures for use in the suspension concentrate of the invention include mixtures with herbicidal amides (such as saflufenacil, dimethenamid-p, and pethoxamid); chloroacetanilides (such as metolachlor, s-metolachlor, and acetochlor); dinitroanilines (such as pendimethalin and trifluralin); nitrophenylethers (such as acifluorfen, fomesafen, lactofen, and oxyfluorfen); benzoic acids (such as dicamba acid, diglycoamine amine salt of dicamba, and tridentate amine salt of dicamba such as bapma-dicamba); phenoxyacetic acids (such as 2.4-d, choline salt of 2.4-d, and 4-chloro-2-methylphenoxy) acetic acid (aka MCPA); and organophosphates (such as glyphosate and glufosinate).

Comb Polymer Dispersant

A comb polymer is used in the present invention to aid dispersion of the insoluble components. Comb polymers are so named because of their structure: a main polymeric backbone chain with two or more, three-way branch points and linear side chains. If the side chains that form the “combs” are identical, the comb polymer molecule is said to be regular. Comb polymers can be formed from a number of polymers including polyetheramines (e.g. U.S. Pat. Nos. 8,247,353 and 8,420,573), hyper comb-branched polymers (U.S. Pat. No. 5,919,442), amphiphilic comb polymers (US 2014/0018277), and PPEM 9376 (Akzo) which is believed to be made with ethoxylated anionic carboxylate-containing copolymer of comb-structure with pendant C14-hydrophobic aliphatic groups, polyalkylene glycol mono(meth)acrylate or allyl alcohol alkoxylate (such as polyethylene glycol allyl ether) in polymerized form, preferably polyethylene glycol monoalkyl ether (meth)acrylate with a molar mass Mn of 100 to 5000 g/mol (US2012/0238641). See also Group F of US 2012/0053221 and U.S. Pat. No. 8,618,022.

The preferred comb polymers for use in the present invention are those made according to WO 2014/191288, the disclosure of which is hereby incorporated by reference. Such copolymers are carboxylated, water soluble, polymers based on one or more ethylenically unsaturated carboxylic acids, 5-55% of which have been esterified with a polyalkoxylated polystyrylphenol. Such water soluble carboxylated polymers may be prepared in two steps by i) radically polymerizing ethylenically unsaturated mono carboxylic acids, bi-carboxylic acids or anhydride thereof, and ii) esterifying in a subsequent step the thus obtained carboxylated polymer with specific amounts of the polyalkoxylated polystyrylphenol such as poly(oxy-1,2-ethanediy), alpha-phosphono-omega-(2,4,6-tris(1-phenylethyl)phenoxy) (CAS 114535-82-9). Even more preferably, a) at least 85% by moles of the monomer units derive from ethylenically unsaturated C3-Cs mono carboxylic acids, bi-carboxylic acids or anhydride thereof and from 0 to 15% by moles of the monomer units derive from one or more non-carboxylated ethylenically unsaturated monomers, b) from 5% to 55% of the carboxylic acid groups of the polymer are esterified with at least one polyalkoxylated polystyrylphenol, the water soluble polymer being obtained by i) radically polymerizing at least 85% by moles of ethylenically unsaturated C3-Cs mono carboxylic acids, bi-carboxylic acids or anhydride thereof and from 0 to 15% by moles of one or more noncarboxylated ethylenically unsaturated monomers, ii) esterifying the thus obtained carboxylated polymer with from 5% to 55% of equivalents, based on the carboxylic acid groups of the polymer, of a polyalkoxylated polystyrylphenol such as distryrylphenol and tristyrylphenol, and also the analogue di- and tri-α-ethylstyrylphenol. The term “polyalkoxylated” mean alkoxylated with more than one mole of at least one alkylene oxide, which is typically ethylene oxide, propylene oxide or butylene oxide.

By way of summary, the polymer of WO 2014/191288 has at least 85 mole %, preferably 100%, of the monomer units derive from ethylenically unsaturated C3-Cs mono carboxylic acids, bi-carboxylic acids or anhydrides thereof that are selected among acrylic acid, methacrylic acid, maleic acid, fumaric acid, crotonic acid, itaconic acid and anhydrides thereof.

From 0 to 15% by moles of the monomer units of the comb polymer derive from one or more non-carboxylated ethylenically unsaturated nonionic or ionic monomers. Examples of such non-carboxylated monomers are am ides, alkyl esters, with or without hydroxyl or amino groups in the ester radical, alcohols, sulfonic acids and ethers with ethylenically unsaturated radicals, olefins and styrene. Specific examples of non-carboxylated monomers are acrylamide, methacrylamide, 2-acrylamido-2-methylpropanesulfonic acid, vinylsulfonic acid, allylsulfonic acid, vinylphosphonic acid, allylphosphonic acid, vinyl acetate, vinyl propionate, methyl acrylate and methacrylate, ethyl acrylate and methacrylate, hydroxyethyl acrylate and methacrylate, hydroxypropyl acrylate and methacrylate, dialkylaminoethyl acrylate and methacrylate, vinylglycol, allyl alcohol, ethylene, propylene, isobutylene, methyl vinyl ether, ethyl vinyl ether, isobutyl vinyl ether, styrene and butadiene. Preferably, the non-carboxylated monomers are nonionic, and the sum of the ethylenically unsaturated C3-Cs mono carboxylic acids, bi-carboxylic acids or anhydrides thereof and the non-carboxylated monomers is 100% by moles, which improves the versatility of the polymer.

The carboxylic acid groups of the water soluble polymer are esterified with at least one polyalkoxylated polystyrylphenol which is polyethoxylated tristyrylphenol, most preferably they are esterified with at least one tristyrylphenol which is polyethoxylated with from 10 to 30 moles of ethylene oxide; from 5 to 55%, preferably from 8% to 30%, most preferably from 10% to 15%, of the carboxylic acid groups of the water soluble polymer are esterified with the polyalkoxylated polystyrylphenol.

Acid Stable Surfactant

One or more acid stable surfactants are preferably used in the present invention to enhance suspensive capacity and storage stability. Generally suitable surfactants include nonionic alkoxylated surfactants and block copolymer surfactants. Examples of useful alkoxylated surfactants for the invention include castor oil ethoxylate, tridecyl alcohol ethoxylate, nonyl phenol ethoxylate, octyl phenol ethoxylate, tristryl phenol ethoxylate, phosphate ester ethoxylte, tallow amine ethoxylate, cocoa amine ethoxylate, and oleyl amine ethoxylate. Preferred acid stable surfactants include alkylphenol ethoxylates and the alkoxylated polyarylphenol phosphates that are described in U.S. Pat. Nos. 4,853,026 and 5,912,267 and alkoxylated polyarylphenol phosphate esters optionally including alkoxylated lignosulfonate salts as described in U.S. Pat. No. 7,238,645.

Redispersion Agent

The present invention also includes the optional use of a redispersion agent in the formulation to avoid the formation of hard sediment and aid in the redispersion and re-suspension of any sediment. While not wishing to be bound by theory, it is believed that the present redispersion agent acts as a soft lattice or nucleating agents that capture precipitating solids whether they are the insoluble active component falling out of dispersion or the second active ingredient (soluble or insoluble in water) that might begin to form sediment crystals. The redispersion agent interacts with the precipitating solids to form a soft cloud on the bottom of the contain that is readily redispersed and suspended with only gentle agitation without forming nozzle clogging agglomerates.

Suitable redispersion agents include finely divided silica, aluminosilicates, aluminomagnesiumsilicates, and water-swellable clays which will hydrate in the presence of water, i.e., will swell in the presence of water. Suitable water swellable clays are from the kaolinite, montmorillomite or ilite groups. Exemplary and preferred montmorillomite clays that can be used in the present invention is bentonite including water-swellable sodium bentonite clay or a low-swellable calcium bentonite clay. A preferred bentonite is sodium bentonite which is basically a hydratable montmorillomite clay of the type generally found in the Black Hills region of South Dakota and Wyoming. This clay has sodium as a predominant exchange ion. However, the bentonite utilized in accordance with this embodiment of the present invention may also contain other cations such as magnesium and iron. There are cases wherein a montmorillomite predominant in calcium ions can be converted to a high swelling sodium variety through a well-known process called “peptizing”. The colloidal clay utilized in this invention may be one or more peptized bentonites.

The redispersion agent may also be a clay of the dioctahedral or trioctahedral smectite group or mixtures thereof. Examples of smectite clays are Beidellite, Nontronite, Hectorite, Sepiolite and Samonite.

Clays used as redispersion agents according to the invention may be subjected to the re-wetting and re-drying treatment described in e.g., U.S. Pat. No. 5,114,893.

Uses

The suspension concentrates of the invention can be used in their suspension concentrate form to control plant growth, preferably via inhibition of plant amino acid synthesis—acetohydroxyacid synthase (AHAS) or acetolactate synthase (ALS)—at application rates consistent with known rates for the specific active ingredient. For example, the suspension concentrate can be combined with an acidifying agent, e.g., in a tank mix procedure or otherwise, to form a herbicidal formulation, and can optionally be further combined with other ingredients such as an additional, different, active herbicidal compounds.

The preferred use for the suspension concentrate of the invention is for use in a process for controlling the growth of undesired plants among desired plants. For example, cloransulam-methyl herbicidal suspensions according to the invention can be used for soil-applied and postemergence control of broadleaf weeds in soybeans. This active ingredient is readily absorbed by broadleaf weeds via roots, shoots, and foliage.

Preferred herbicidal formulations of the invention exhibit a pH within the range from above about 1.5 to about 5, preferably about 2 to about 4 that can be adjusted with an agrochemically-friendly acid such as phosphoric acid. The low pH allows for reduced formation of crystals, particle agglomerates and solubility of the active ingredient.

### EXAMPLES

### Example 1

In this example, a representative suspension concentrate according to the invention includes the following ingredients in Table 2:

TABLE 2

| Ingredients | Wt % | Purpose |
|---|---|---|
| Chloransulam-methyl, 99.0% A.I. | 22.630 | Active Ingredient |
| Wetting agent (optional) | 1.500 | Primarily as acidic wetting |
| | | agent with dispersant |
| | | effects |
| Nonionic block copolymer | 1.000 | Wetting agent |
| Comb polymer | 1.000 | Dispersant |
| Bentonite swelling clay | 1.000 | Rheology Aid |
| Polystyryl phenol-Poly(oxy-1,2- | 1.000 | Acidic dispersant/wetting |
| ethanediy), alpha-phosphono- | | agent |
| omega-(2,4,6-tris(1- | | |
| phenylethyl)phenoxy) | | |
| Propylene Glycol | 4.500 | Anti-Freeze |
| Xanthan gum | 0.400 | Thickener |
| Biocide (20% water and | 0.100 | Anti-Microbial agent |
| dipropylene glycol solution of 1,2- | | |
| benzisothiazolin-3-one) | | |
| Polydimethylsiloxane emulsion | 0.200 | Antifoaming agent |
| Water | 67.920 | Diluent |

The formulation was made as follows:

1. Weigh 90% of the water into a mixing vessel equipped with an agitator and a load cell.

2. Weigh wetting agent (1) into the water and mix to incorporate.

3. Weigh wetting agent (2) into the mixing vessel and mix to incorporate.

4. Weigh comb polymer into the mixing vessel and mix to incorporate.

5. Weigh polyalkoxylated polystyryl phenol into the mixing vessel and mix to incorporate.

6. Weigh cloransulam-methyl technical into the mixing vessel and mix until fully dispersed.

7. Weigh swelling clay into the mixing vessel and mix until incorporated.

8. Wet mill the dispersion until the desired particle size is achieved, preferably 2-3 microns median particle size.

9. Transfer the milled dispersion to a tared mixing vessel and record the weight.

10. IMPORTANT: The post-milled dispersion batch weight will typically be less than the pre-mill batch weight, therefore ratio the remaining ingredients based on the post milling batch weight in order to balance the formula correctly.

11. Add remaining ingredients and mix to incorporate.

### Example 2

An example of a suspension concentrate containing a greater amount of the active ingredient is presented in this example. The ingredients are listed in Table 3. The formulation process was the same as in example 1.

TABLE 3

| Ingredients | Wt % | Purpose |
|---|---|---|
| Cloransulam-Methyl, | 40.490 | Active Ingredient |
| 97.8% A.I. | | |
| Comb polymer | 2.000 | Dispersant |
| Block copolymer | 1.500 | Dispersant |
| Polyalkoxylated polystyryl | 1.500 | Dispersant |
| phenol | | |
| Tridecyl alcohol | 0.500 | Wetting agent |
| Bentonite swelling clay | 0.650 | Rheology Aid |
| Biocide (20% water and | 0.100 | Anti-Microbial |
| dipropylene glycol solution | | |
| of 1,2-benzisothiazolin-3- | | |
| one) | | |
| Propylene Glycol | 4.000 | Anti-Freeze |
| Xanthan gum | 0.150 | Rheology Aid |
| Polydimethylsiloxane | 0.250 | Antifoam |
| emulsion | | |
| Phosphoric acid, 85% | 0.100 | pH Modifier |
| Water | 48.760 | Diluent |

### Example 3

The formulations of Examples 1 and 2 were tested by standard testing for two year simulated storage stability. In each case, the formulation did not flocculate and any precipitate was soft and readily re-dispersed with only minor effort. Efficacy testing of the active ingredient did not reveal any material degradation in performance. Thus, the formulations of the invention were deemed good and commercially acceptable.

It will be understood that the preferred embodiments described herein are not intended to serve as substantive limitations on the scope of the appended claims and are presented for illustrative and explanatory purposes.

Each of the patents referred to herein is hereby incorporated by reference.

What is claimed is:

1. An aqueous suspension concentrate composition comprising: (a) a first active ingredient comprising one or more triazolopyrimidine, triazolone, pyrazole or oxazole herbicides; (b) optionally, a second active ingredient, (c) a dispersant comprising a comb polymer; (d) a nonionic, alkoxylated surfactant or a block copolymer surfactant, and (e) optionally, a re-dispersing agent, wherein said aqueous suspension concentrate exhibits an acidic pH within the range from about greater than about 2 to about 4.

2. A suspension concentrate according to claim 1 wherein said first active ingredient comprises a triazolopyrimidine herbicide.

3. A suspension concentrate according to claim 2 wherein said first active ingredient comprises a triazolopyrimidine herbicide selected from the group consisting of cloransulam, cloransulam-methyl, diclosulam, florasulam, flumetsulam, metosulam, penoxsulam, and pyroxsulam.

4. A suspension concentrate according to claim 2 wherein said first active ingredient comprises cloransulam or cloransulam-methyl.

5. A suspension concentrate according to claim 1 wherein said first active ingredient comprises a triazolone herbicide.

6. A suspension concentrate according to claim 5 wherein said first active ingredient comprises a triazolone herbicide selected from the group consisting of amicarbazone, bencarbazone, carfentrazone, flucarbazone, ipfencarbazone, propoxycarbazone, sulfentrazone, and thiencarbazone.

7. A suspension concentrate according to claim 6 wherein said first active ingredient comprises sulfentrazone.

8. A suspension concentrate according to claim 1 wherein said first active ingredient comprises a pyrazole herbicide.

9. A suspension concentrate according to claim 1 wherein said first active ingredient comprises a pyrazole herbicide selected from the group consisting of azimsulfuron, difenzoquat, halosulfuron, metazachlor, metazosulfuron, pyrazosulfuron, and pyroxasulfone.

10. A suspension concentrate according to claim 1 wherein said first active ingredient comprises an oxazole herbicide.

11. A suspension concentrate according to claim 1 wherein said first active ingredient comprises an oxazole herbicide selected from the group consisting of carboxazole, fenoxasulfone, isouron, isoxaben, isoxachlortole, isoxaflutole, methiozolin, monisouron, pyroxasulfone, and topramezone.

12. A suspension concentrate according to claim 1 wherein said comb polymer comprises a carboxylated water soluble polymer in which a) at least 85% by moles of the monomer units derive from ethylenically unsaturated C3-C5 mono carboxylic acids, bi-carboxylic acids or anhydride thereof and from 0 to 15% by moles of the monomer units derive from one or more non-carboxylated ethylenically unsaturated monomers, b) from 5% to 55% of the carboxylic acid groups of the polymer are esterified with at least one polyalkoxylated polystyrylphenol.

13. A suspension concentrate according to claim 12 wherein in said carboxylated water soluble polymer, 100% of the monomer units derive from ethylenically unsaturated C3-C5 mono carboxylic acids, bi-carboxylic acids or anhydride thereof.

14. A suspension concentrate according to claim 12 wherein the carboxylic acid groups of the carboxylated water soluble polymer are esterified with a polyalkoxylated polystyrylphenol which is a polyethoxylated tristyrylphenol.

15. A suspension concentrate according to claim 1 further comprising a redispersion agent comprising a water swellable clay.

16. A suspension concentrate according to claim 15 wherein said clay comprises bentonite clay.

17. A suspension concentrate according to claim 1 comprising a second active ingredient that comprises at least one of a herbicidal amide, a herbicidal chloroacetanilide, a herbicidal dinitroaniline, a herbicidal nitrophenylether, a herbicidal benzoic acid, a herbicidal phenoxyacetic acid, or a herbicidal organophosphate.

18. A suspension concentrate according to claim 17 wherein said second active ingredient comprises at least one of saflufenacil; dimethenamid-P; pethoxamid; metolachlor; S-metolachlor; acetochlor; pendimethalin; trifluralin; acifluorfen; fomesafen; lactofen; oxyfluorfen; dicamba acid; diglycoamine amine salt of dicamba; tridentate amine salt of dicamba; 2,4-D; choline salt of 2,4-D; 4-chloro-2-methylphenoxy) acetic acid; glyphosate; and glufosinate.

19. A suspension concentrate according to claim 1 comprising sulfentrazone and dicamba acid.

20. A suspension concentrate according to claim 1 comprising sulfentrazone and 2,4-D.

21. A suspension concentrate according to claim 1 comprising cloransulam-methyl and dicamba acid.

22. A suspension concentrate according to claim 1 comprising sulfentrazone and 2,4-D.

23. A suspension concentrate according to claim 1 wherein said composition comprises ingredient concentrations according to the following table:

| Ingredient | Range (total wt %) |
|---|---|
| Active ingredient | 5-85 |
| Comb polymer dispersant | 0.01-15 |
| Nonionic surfactant | 0.25-10% of each |
| Redispersion agent | 0.1-10 |

24. A suspension concentrate according to claim 1 wherein said composition comprises ingredient concentrations according to the following table:

| Ingredient | Range (total wt %) |
|---|---|
| Active ingredient | 5-65 |
| Comb polymer | 0.1-7.5 |
| dispersant | |
| Nonionic surfactant | 0.5-5% of each |
| Redispersion agent | 0.3-5 |

25. A suspension concentrate according to claim 1 further comprising phosphoric acid.

26. A process for controlling the growth of unwanted plants by a process that comprises applying to the loci of the unwanted plants a diluted suspension concentrate, said concentrate comprising: (a) a first active ingredient comprising one or more triazolopyrimidine, triazolone, pyrazole or oxazole herbicides; (b) optionally, a second active ingredient, (c) a dispersant comprising a comb polymer; (d) a nonionic, alkoxylated surfactant or a block copolymer surfactant, and (e) optionally, a re-dispersing agent, wherein said aqueous suspension concentrate exhibits an acidic pH within the range from about greater than about 2 to about 4.
